(19) United States
(12) Patent Application Publication
(10) Pub. No.: US 2016/0016269 A1
(43) Pub. Date: Jan. 21, 2016

(54) TOOL QUICK CHANGING DEVICE

(71) Applicant: GIMATIC S.r.l., Roncadelle (BS) (IT)

(72) Inventor: Giuseppe MAFFEIS, RONCADELLE (BS) (IT)

(73) Assignee: GIMATIC S.r.l., Roncadelle (BS) (IT)

(21) Appl. No.: 14/789,073

(22) Filed: Jul. 1, 2015

(30) Foreign Application Priority Data
Jul. 15, 2014 (IT) BS2014A000129
May 19, 2015 (IT) 102015000015702

(51) Int. Cl. B23Q 3/155

(52) U.S. Cl. CPC B23Q 3/15553

(57) ABSTRACT

A tool quick changing device includes a main body constrainable to an outside handling system, a blocking disk housed in the main body and rotating with respect to the latter on a rotation axis between a blocking position and a releasing position, driving means of the blocking disk, and a male portion designed to be fastened to a tool to be handled. The main body is provided with a housing seat in which the male portion can be inserted by a translatory movement. The blocking disk, in the releasing position, does not intercept the housing seat of the male portion, therefore the latter remaining free for being inserted and drawn out; on the contrary, in the blocking position the blocking disk intercepts at least partially the housing seat in order to hold the male portion therein which, cannot be drawn out and separated from the main body.

### INCORPORATION BY REFERENCE

This Patent Application claims the priority of Italian Application No. BS2014A000129, filed on Jul. 15, 2014 and 102015000015702, filed on May 19, 2015, the entire contents of which are incorporated by reference herein as if fully set forth.

### FIELD OF THE INVENTION

The present invention refers to a tool quick changing device, specifically an electrically supplied and especially compact tool changing device.

### BACKGROUND

In the industrial automation field the use of tool changing devices allowing a robotized manipulator, for example an articulated arm, to take and handle on case-by-case basis the tool needed for a given machining is known.

In different environments the needs are not so different.

For example, in the medical field machineries are known which are provided with a plurality of diagnostic instruments that must be selectively handled from a non-use position and a use position.

In order to be able to take the desired tool or instrument on case-by-case basis, manipulators are provided with a tool changing device; object of the present invention is an electrically operated tool changing device.

Broadly speaking, the currently available devices comprise a male portion intended for being fastened to the tool or instrument to be taken and handled, and a main body intended for being fastened permanently to the manipulator, for example by means of screws, in its turn provided with a female portion arranged to receive and hold the male portion for the necessary time.

Members intended for reversibly blocking the male portion in the female portion are housed in the body of the tool changing devices. Traditionally, “tool quick changing devices” mean those tool changing devices in which the blocking members move at high speed for rapidly catching and releasing the male portion, for example in less than 1 second, and therefore the tool or instrument.

Electrically or pneumatically operated tool changing devices are available, depending on whether the driving members are operated by an electric motor or else a pressurized fluid.

For example, the German Company SCHUNK GmbH & Co KG makes a plurality of electrically or pneumatically operated tool changing devices.

An electrically operated tool changing device is commercialized with the trade name ‘Quick Change system EWS’, described in detail in the technical form available at the following Internet link: http://www.schunk.com/schunk_files/attachments/EWS_Highlights_{—}2013-11_EN.pdf.

The Applicant found that known tool changing devices usually have a complex structure, are bulky, heavy and expensive to be made.

The weight is a strongly significant aspect, because a tool changing device is normally handled together with the tool or the instrument and therefore concurs to increase the inertia of moving masses.

Size of tool changing devices is important too. As the bulk increases the versatility similarly decreases, since the operation range of the manipulator on which the tool changing device is assembled is limited. Obviously, a tool changing device having great size will not be used for taking tools or instruments in tight spaces.

It is moreover desirable simplifying the structure of tool changing devices as much as possible also for minimizing manufacturing and maintenance costs thereof and the power needed for the respective operation.

Another drawback of known solutions is that, usually, they do not allow detecting precisely the occurrence of blocking or releasing of the male portion. In other words, they do not allow verifying simply and reliably during time if the tool has been caught or released.

### SUMMARY

Object of the present invention is to provide a tool changing device solving the drawbacks of the conventional solutions, which is structurally simple, compact, quite lightweight, reliable and inexpensive.

A particular object of the present invention is to provide a tool changing device that allows verifying with extreme believability and reliability when the tool has been caught or released.

It is a further object of the present invention to provide an improved tool changing device, able to block the male portion with a very low friction.

Another object of the present invention is to provide a tool changing device guaranteeing a lifetime as long as possible also in aggressive working environments, for example in presence of aggressive chemical agents.

Therefore the present invention concerns a tool changing device, quickly operated, according to claim 1.

In particular, the device comprises:
a main body, for example having a box shape, constrainable to an outside handling system;
a blocking disk housed in the main body and rotating with respect to the latter, in the two clockwise and counterclockwise ways, on a rotation axis between a blocking position and a releasing position, which will be defined hereinafter;
driving means of the blocking disk for driving the rotations; and
a male portion designed to be fastened to a tool to be handled.

The main body is provided with a housing seat of the male portion along said rotation axis, meaning that the male portion can be inserted in the corresponding housing seat by a translatory movement along the rotation axis of the blocking disk.

The blocking disk, in the releasing position, does not intercept the housing seat of the male portion, therefore the latter remaining free for being inserted and drawn out; on the contrary, in the blocking position the blocking disk intercepts at least partially the housing seat in order to hold the male portion therein which, in this case, cannot be drawn out and separated from the main body. In this way the reversible coupling of the male portion to the main body of the device is achieved.

The tool changing device according to the present invention can be defined “tool quick changing device” as a very little, and therefore quick, rotation of the blocking disk is sufficient for holding the male portion in the corresponding housing seat.

The suggested solution offers several advantages.

First of all, the tool changing device is particularly compact: the axial extent of the male portion and the corresponding housing seat can be minimized, because the blocking disk is a substantially thin member in itself. For example, the blocking disk can have a thickness comprised between 2 mm and 6 mm and the male portion can extend axially for 1 cm-3 cm. This allows the axial bulk of the main body of the device to be limited to less than 4 cm. With respect to the average of the tool changing devices available on the market, the device according to the present invention can be considered “flat”. Also the bulk in the radial direction can be limited, for example less than 12 cm.

Another advantage is that the device structure is strongly simple. The number of components is limited and the respective arrangement allows assembling and disassembling the device rapidly and with high simplicity, without having necessarily to use specific tools.

Preferably, for example, the blocking disk is not supported in the main body through apposite bearings, but simply it is supported along its own circumference by the inner surfaces of the seat defined in the same body for the disk.

Having a simple structure, the device is also lightweight if compared to traditional solutions. This plays a key role in managing inertias by the handling system the device is combined with. For example, a device according to the present invention can be implemented with the blocking disk made of hardened steel, the box-shaped body made of aluminum and the driving means made partially of brass and having a total weight lower than 1 kg; the device with all these features can rise tools or instruments whose weight is equal to 15 kg and higher.

The afore mentioned features concur in rendering the tool changing device particularly versatile and adapted to be used not only in the industrial automation field in the factory but, for example, also in medical, diagnostic and laboratory device fields. For example, the tool changing devices can be used in ophthalmological diagnostic apparatuses equipped with a plurality of diagnostic instruments that must be selectively taken and handled by an appropriate system for their user provisioning.

In the preferred embodiment the blocking disk is provided with a toothing next to at least part of its perimeter, i.e. a circumferential toothing. The driving means engage such a toothing to impart the clockwise or anticlockwise rotation. This feature is particularly advantageous for what concerns the inner layout of the device, since the driving means can be positioned substantially tangential to the blocking disk, thereby favoring the compactness of the device on the whole.

In general, different arrangements of the driving means can be provided.

In the preferred embodiment the driving means comprise a reversible electric motor, i.e. able to rotate alternately in the two ways depending on the polarity of the power-line voltage, and a worm. The electric motor and the worm are both housed in the main body. The worm is constrained to the shaft of the electric motor and meshes directly the toothing of the blocking disk. In practice, the worm is keyed to the shaft of the electric motor and meshes the circumferential toothing of the blocking disk. Clockwise rotations of the worm cause anticlockwise rotations of the blocking disk and vice versa.

Alternatively, the reversible electric motor can be assembled outside the main body and a transmission element, for example a steel cable, operatively connects the shaft of the electric motor to the worm housed in the main body. This solution can be adopted, for example, when the tool changing device must be particularly compact and the power necessary for the blocking disk rotation is minimal.

In both solutions the worm is positioned substantially tangential with respect to the blocking disk and on the same lying plane.

Preferably, the worm meshes directly the blocking disk and is directly constrained to the electric motor, with no interposition of a reduction gear.

Still alternatively, the driving means can comprise a cylinder and piston assembly, which is pneumatically driven and wherein the piston is constrained to the blocking disk. This solution is adapted for applications in which high powers are required for the blocking disk rotation, for example when the items to be handled are particularly heavy.

In the preferred embodiment the male portion comprises two or more side projections, for example two or more pins protruding laterally, so that when the male portion is inserted into the respective housing seat, the side projections extend radially with respect to the rotation axis of the blocking disk. The housing seat in the main body has a substantially complementary shape with respect to the male body. This allows a plurality of male portions of corresponding shape having scaled size to be accommodated.

Preferably, the male portion is substantially cylindrical and can be coaxially inserted into the housing seat and the projections are pins radially arranged with angles at the center of about 120°.

In an embodiment the blocking pins are rotating on themselves in the respective seats obtained in the male portion, so that the friction generated with the blocking disk when the latter is rotating is of rolling and not sliding type. Therefore a more gentle operation of the device can be achieved and less starting power is required by the electric motor, or in general the driving means are subjected to less stresses with respect to a solution having fixed pins and sliding friction.

The blocking disk is provided with a lobate through-hole coaxial with the rotation axis and in which the male portion can be inserted. Through the lobes, i.e. through the nick provided around the through hole, the projections of the male portion are inserted into the housing seat. In practice, the housing seat of the male portion is defined both by the surfaces of the main body and the edge of the lobate through-hole of the blocking disk.

Preferably, the side of the blocking disk facing the part opposed to the male portion, when it is inserted into the housing seat, has at least one circumferential taper, or an inclined plane, in the proximity of each lobe, so that:
the rotation of the blocking disk in the blocking position makes the tapers or inclined planes intercept the respective projections (the pins) of the male portion and generate an axial thrust onto the same tapers that blocks the male portion on the main body, and
the rotation of the blocking disk in the releasing position makes the tapers or inclined planes not intercept the respective projections of the male portion, therefore the latter being free of escaping from the housing seat.

Preferably, the male portion and the blocking disk together define a substantially bayonet coupling, even if in this case the male portion does not rotate in the housing seat but the blocking disk does, rotating around the male portion inserted in the seat.

Preferably, the blocking disk is positioned in the main body at the median plane of the housing seat of the male portion. When the male portion is inserted in the accommodating seat, the blocking disk is in a plane in-between the projections of the male portion and the part of the male portion intended to be fastened to the tool or instrument.

In the preferred embodiment the tool changing device further comprises a magnetic proximity sensor arranged to generate a signal when the male portion is correctly inserted into the housing seat. A control unit, also a remote one, acquires the signal generated by the sensor and prevents the blocking disk from being operated if the male portion is not correctly inserted in the housing seat.

Preferably, the device further comprises an encoder housed in the main body and arranged in order to each time detect the rotation amplitude the blocking disk really made. For example, the encoder detects (counts) the number of teeth of the blocking disk that pass in front of the encoder itself when the blocking disk is rotating.

In an alternative embodiment the device comprises an encoder different from the previous one, which comprises a sensor detecting the strength of the magnetic field generated by one or more permanent magnets mounted on board of the blocking disk. The strength changes as the distance among the sensor and the magnets on the blocking disk changes. Therefore, the rotation of the blocking disk causes a corresponding variation of the strength of the magnetic field the sensor can detect. Each strength value of the magnetic field is indicative of the angular position of the blocking disk.

In an embodiment, two permanent magnets are fastened to the blocking disk at a nick obtained along its circumference. The magnets are aligned to each other and they are arranged along a direction parallel to the tangent of the blocking disk. The sensor is assembled as stationary in the box-shaped body and faces the edge of the blocking disk. With this arrangement, the strength of the magnetic field the sensor can detect, when the blocking disk is rotating, has a trend with at least three thresholds corresponding to the disk in the releasing position, the disk in the blocking position and the disk in the intermediate position.

An electronic circuit connected to the encoder and to electric driving means, for example the control unit described above, is programmed to detect a possible current peak in the driving means and to receive the signal generated by the encoder, the signal being indicative of the rotation amplitude the blocking disk made. When necessary, i.e. when the disk rotation has been enough to achieve an effective clamping effect of the projections of the male portion, the electronic circuit disrupts the electric power supply to the driving means.

Therefore, in general, the proposed solution is effective and assures the clamping of the male portion in the respective seat with no electric power waste, since the driving means are supplied only for the time necessary to rotate the blocking disk. In other words, when the male portion is blocked in the respective seat, the device does not absorb current.

In view of what above, it is clear that the device supports effectively the male portion and the load applied thereto also in case of electrical black-out.

Preferably, the box-shaped body is liquid tight, or almost liquid tight, so that the device can be subjected to frequent washes with detergents or disinfectant agents with no damages. This aspect, at first seeming irrelevant for a device use in industrial environments, becomes important in medical fields in order to prevent accumulation of dirt in the device that favors the accumulation of bacterial load and, therefore, potential infection sources for patients using the medical devices handled by the device itself.

### BRIEF DESCRIPTION OF THE DRAWINGS

Further characteristics and advantages of the invention will be more evident from a review of the following specification of a preferred, but not exclusive, embodiment, shown for illustration purposes only and without limitation, with the aid of the attached drawings, in which:

FIG. 1 is a rear elevation view of a part of the tool changing device according to the present invention;

FIG. 2 is a side elevation view of the device shown in FIG. 1;

FIG. 3 is a top view of the device shown in FIG. 1;

FIG. 4 is an exploded view of the device shown in FIG. 1, assembled in all its parts;

FIG. 5 is a vertical section view of the device shown in FIG. 1;

FIG. 6 is a front view of a component of the device shown in FIG. 1;

FIG. 7 is a side view of the device shown in FIG. 4;

FIG. 8 is an elevation view of a part of the device shown in FIG. 4, partially disassembled;

FIG. 9 is an axially symmetrical section view of the device shown in FIG. 4;

FIG. 10 is an exploded view of a second embodiment of the device according to the present invention, without the male portion;

FIG. 11 is a vertical section view of the device shown in FIG. 10;

FIG. 12 is an enlargement of a part of FIG. 11; and

FIG. 13 is a quality chart relating to the device shown in FIG. 10.

### DETAILED DESCRIPTION OF THE PREFERRED EMBODIMENTS

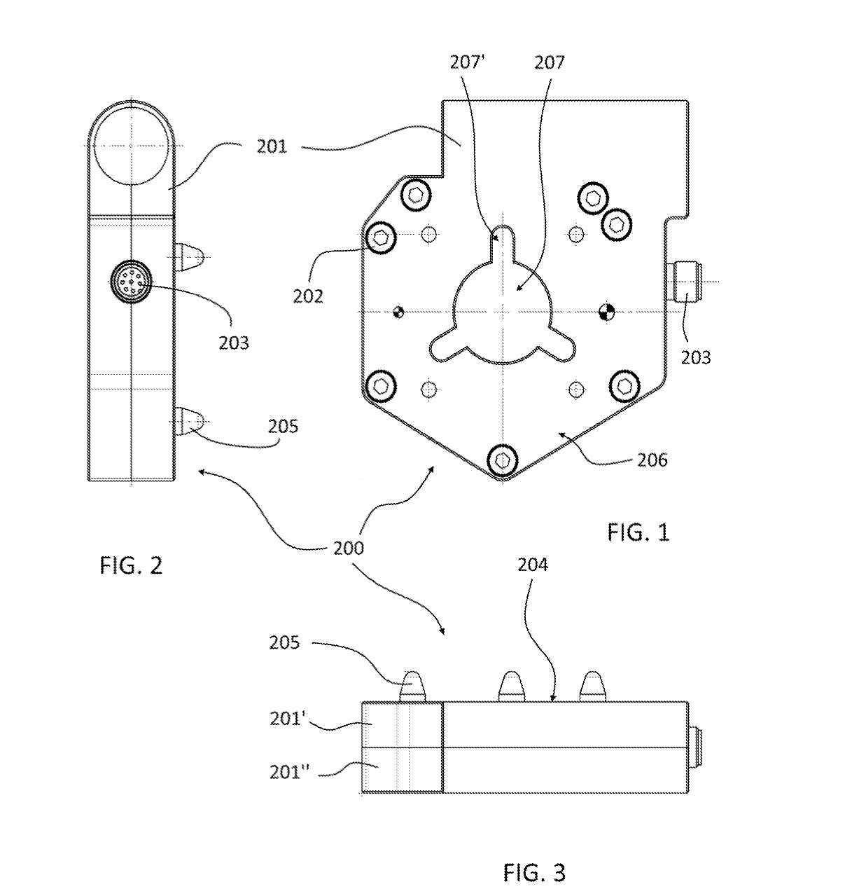

FIGS. 1-9 show a device 100 according to the present invention, comprising a first assembly 200 and a second separated assembly 300. The assembly 200 is intended to be fastened to a manipulator or similar handling system and the assembly 300 is intended to be fastened to the tool or the object or instrument to be taken and handled.

In practice, the assembly 300—and with it the tool or the corresponding instrument—is caught and raised by the assembly 200 and the respective manipulator.

Particularly referring to FIGS. 1-3, the first assembly 200 comprises a main box-shaped body 201, which defines an inner space in which some components of the device are housed.

In particular, the main body 201 is defined by two covers 201′ and 201″ screwed one to another by means of the screws 202.

An electric connector 203 is present on a side of the main body 201.

Three aligning and centering pins 205 projects from the front face 204 of the main body 201. The rear face 205 is intended to be fastened to a manipulator or equivalent handling system.

Through the main body 201 a housing seat 207 is defined, in practice a through hole conveniently shaped for accommodating a complementary shaped element.

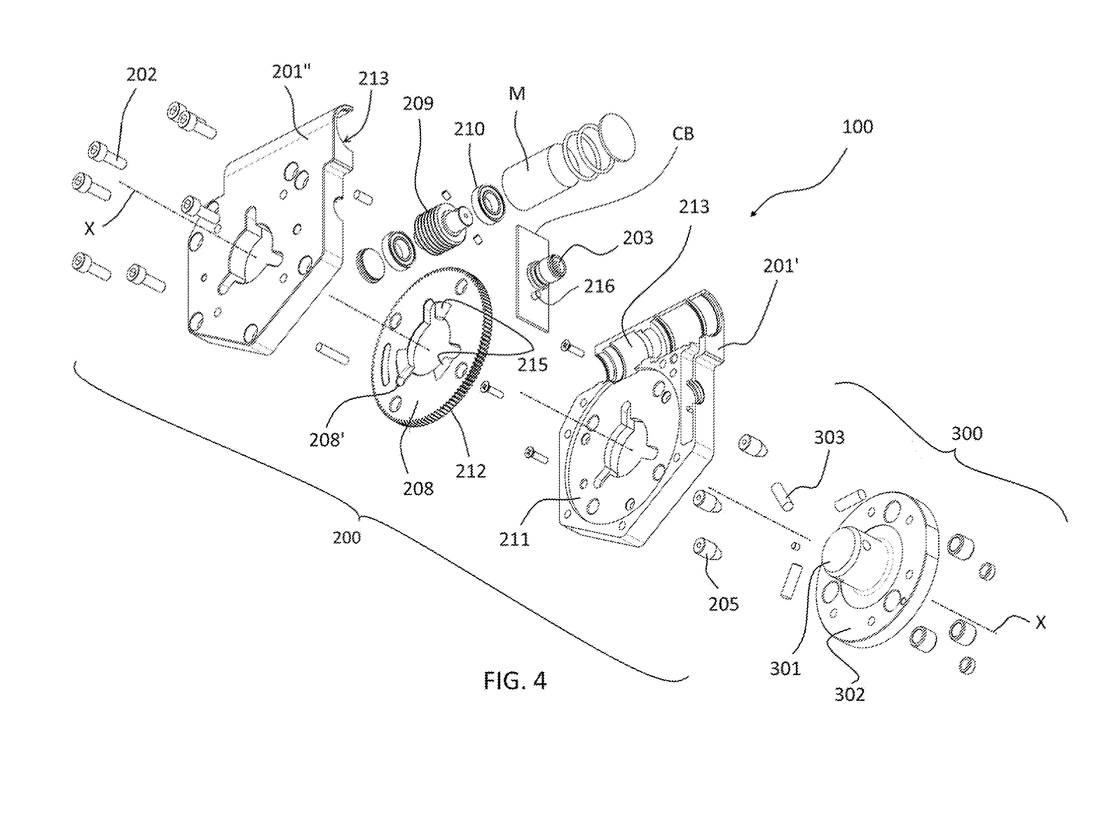

FIG. 4 is an exploded view of the complete device 100. In the main body 201 a blocking disk 208, a reversible electric motor M and a worm 209 supported by corresponding bearings 210 are housed.

The circular blocking disk 208 is housed in the main body 201 so that to rotate on the rotation axis X-X. In particular, the blocking disk 208 moves on corresponding tracks 211 obtained inside the covers 201′ and 201″. On the perimetrical edge of the blocking disk 208 there is the toothing 212.

The motor M and the worm 209 are housed in a corresponding seat 213 so that to be aligned and substantially tangential to the blocking disk 208. The worm 209 is keyed to the shaft of the electric motor M, so that the clockwise and anticlockwise rotations of the motor are transmitted directly to the worm 209.

Between the motor M and the worm 209 there is not a speed reducer. In alternative, if necessary according to the features of the electric motor, a speed reducer can be interposed between the motor and the worm.

In its turn the worm 209 meshes directly the perimetrical toothing 212 of the blocking disk 208 in order to make it rotate clockwise and counterclockwise on the axis X-X.

As clearly evident from FIG. 4, the housing seat 207 is defined by corresponding through holes obtained across the covers 201′ and 201″ and the blocking disk 208.

In the example shown in figures la, the housing seat 207 is a trilobate circular through hole, i.e. it is provided with three lobes 207′ oriented so that to form corresponding angles of 120° at the center.

The function of the housing seat 207 is to accommodate the assembly 300 at least in part.

The assembly 300 comprises a male portion 301 and a corresponding flange 302 for coupling to the tool/instrument to be handled. In the example shown in figures, the male portion 301 is substantially cylindrical and has a diameter corresponding to the diameter of the housing seat 207. Three pins 303 are inserted radially in corresponding holes obtained in the male portion 301, along directions forming a center angle of 120°.

In practice, the male portion 301, with the properly assembled pins 303, can be inserted perfectly in the housing seat 207 through a translatory movement along the axis X-X, taking care of aligning the pins 303 with the lobes 207′, meaning that the pins 303 must cross the corresponding lobes 208′ obtained through the blocking disk 208.

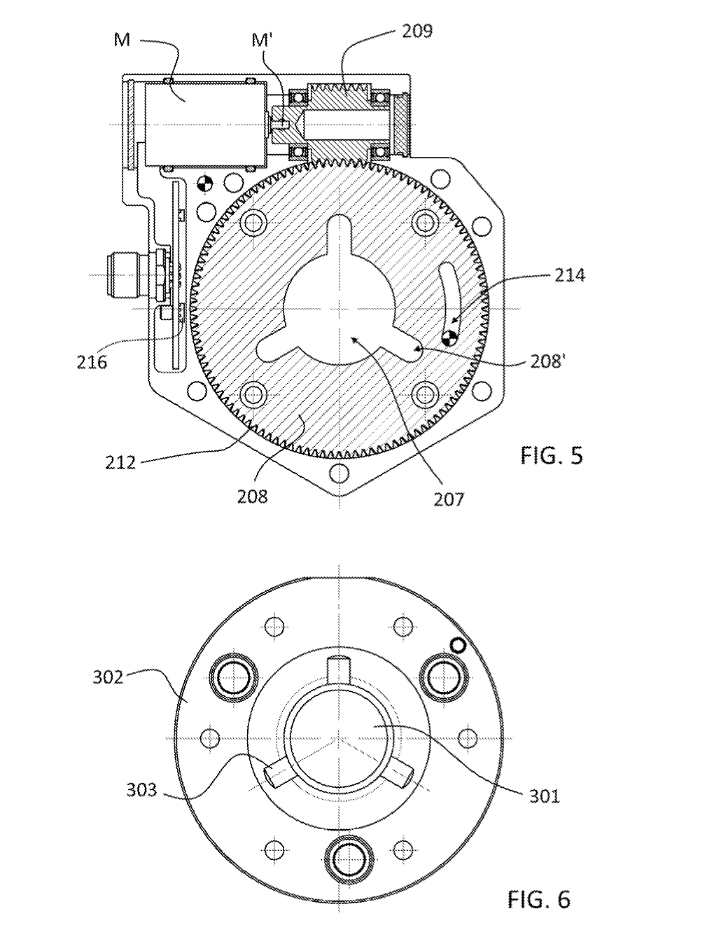

FIG. 5 shows a vertical section of the assembly 200. It is evident that the worm 209 is keyed to the shaft M′ of the electric motor M and meshes directly the toothing 212 of the blocking disk. A limit stop 214 comprising a slot and a pin limits the clockwise and the counterclockwise rotations of the blocking disk in a predefined angle.

In FIG. 5, the blocking disk 208 is shown in the releasing position in which it does not intercept the lobes 207′ of the housing seat, de facto allowing the male portion 301 to be inserted.

The operation of the device 100 is simple: once the male portion 301 has been inserted in the housing seat 207, the motor M is activated and drives the blocking disk 208 into rotation through the worm 209. By rotating, the blocking disk 208 moves to the blocking position shown in FIG. 8: the disk now intercepts the lobes 207′ and prevents the male portion 301 from being drawn out from the seat 207.

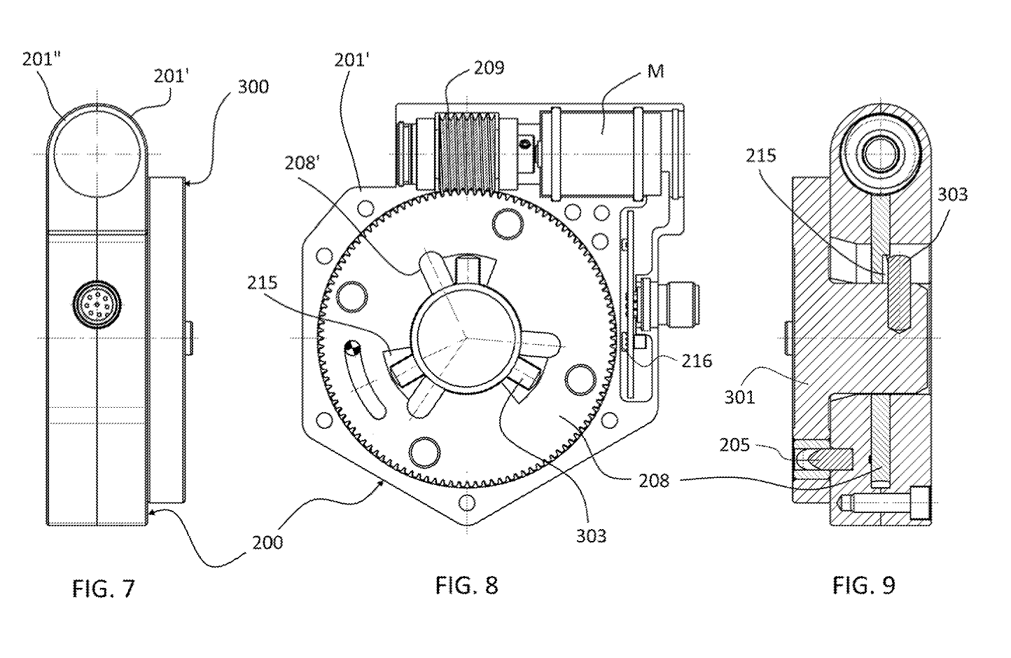

FIG. 7 corresponds to FIG. 2 but, differently from the latter, shows the assembly 300 operatively inserted in the assembly 200.

FIG. 8 is an elevation view of the device 100 with the male portion 301 inserted in the housing seat 207 and the pins 303 tightened to the blocking disk 208.

By comparing FIGS. 5 and 8 it is more simple to understand that the rotation (counterclockwise when looking the sheet) of the blocking disk 208 allows intercepting the lobes 207′ of the housing seat 207, so that the pins 303 of the male portion 301 cannot escape from the housing seat 207.

By considering the relative movement between the blocking disk 208 and the male portion 301 with the pins 303 thereof, the afore-described coupling can be named bayonet coupling.

In a variation of the present invention, particularly effective because minimizing the starting power of the motor M, it is provided that the pins 303 can rotate on themselves in the respective seats of the flange 302. This feature allows having a rolling friction and not a sliding friction between the pins 302 and the blocking disk 208. A “smooth” operation of the device 100 is achieved and the wear between parts is reduced to minimum. In order to prevent the pins 302 from escaping from the seats of the flange 302, it is possible to use retaining rings of Seager type, or other equivalent retaining systems.

FIGS. 4 and 8 show another detail: at the through lobes 208′ obtained in the blocking disk 208, there are some tapers 215 that can also be defined inclined planes. In practice, the inclined planes 215 are arranged as ramps for the pins 301 when the blocking disk 208 rotates for moving to the blocking position. De facto, the rotation involves the compensation of possible clearances among the pins 301 and the corresponding inclined planes 215. In addition, the inclined planes 215 apply on the corresponding pins 301 a substantially axial thrust serving for holding firmly the assembly 300 on the assembly 200, i.e. it serves for making the coupling stable to handle effectively the tool or instrument combined with the assembly 300.

Preferably, as shown in figures, the inclined planes 215 extend along a circle arc starting from the corresponding lobe 208′.

FIG. 9 is a section view showing clearly the action of the inclined planes 215 onto the pins 301. As can be noted, the blocking disk 208 interposes among the pins 303 of the male portion 301 and the exit from the housing seat 207. Preferably, the blocking disk 208 is positioned on a median plane with respect to the depth of the housing seat 207.

In FIGS. 4, 5 and 8, with the numeral reference 216 is denoted a magnetic, capacitive or inductive encoder, etc., arranged to generate an electric signal indicative of the number of teeth passing in front of the same encoder when the blocking disk 208 rotates. A little printed circuit CB, visible in FIG. 4 at the connector 203, is configured to perform the processing of the electric signal generated by the encoder—in order to calculate the amplitude of the rotation the blocking disk 208 effectively made—and of the value of current absorbed by the motor M at a given moment. The circuit CB is preferably programmed to compare the amplitude of the just described rotation (i.e. the angle run by the disk 208) with the value of the current instantly absorbed by the motor M. In presence of an absorption peak, it disrupts the supply to the motor M in order to prevent malfunctions, overheating and failures thereof.

In its turn, electric signals generated by the circuit CB are sent to an outside control unit connected to the connector 203.

In every case, the blocking disk 208 cannot counter-rotate autonomously to the releasing position. This circumstance can happen only when the motor M reverses the rotation of the shaft M′, for the coupling safety benefit.

FIGS. 1-9 show evidently that the device 100 according to the present invention has an extremely simple structure and, therefore, can be made compact. This leads to a great versatility and the possibility of uses in several application fields, the handling of fragile diagnostic instruments not being the last.

In alternative to the activation with the motor M inserted in the main body 201, the device 100 can be implemented with the motor M on the outside, for example positioned on a robotic arm to which the device 100 itself is combined with. In this case the rotary movement of the shaft M′ is transmitted to the worm by means of a transmission cable (not shown).

Still alternatively, in place of the electric motor M the device 100 can be pneumatically driven (not shown), for example compressed air, and in this case a cylinder and piston assembly is arranged in the seat 213, where the piston is connected to the blocking disk 208. This solution can be preferred when high powers are necessary.

Even if not shown in figures, preferably the device 100 comprises a proximity sensor, for example of magnetic or capacitive type, positioned in the main body 201 to detect when the male portion 301 is correctly inserted in the housing seat 207 and generate a corresponding electric signal processed by the control unit.

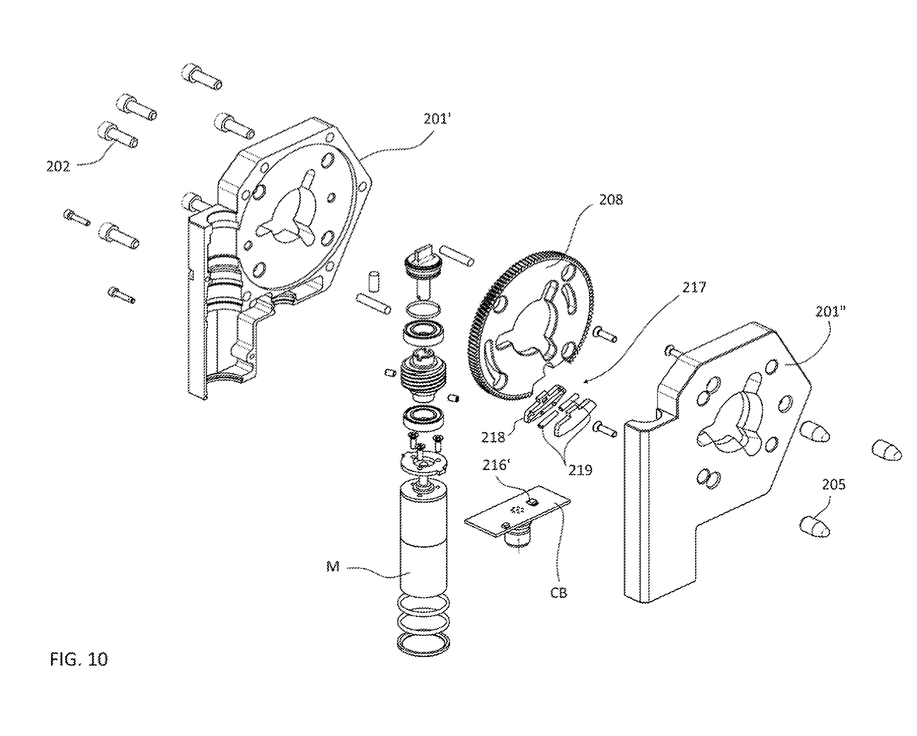

FIG. 10 is an exploded view of a second embodiment similar to the first one (numeral references, which are the same of those used in the preceding figures, identify equivalent elements) but, with respect to that one, is different because the sensor 216′ assembled on the printed circuit CB is not intended to count the number of the teeth of blocking disk 208. A magnet assembly 217 is assembled on the blocking disk. In substance, the magnet assembly 217 lies at the edge of the blocking disk 208 and moves integrally therewith. The sensor 216′ and the magnet assembly 217 define a magnetic encoder.

The magnet assembly comprises a casing 218 inside which two permanent magnets 219 are housed and aligned along a geometrical axis almost tangential with respect to the circumferential edge of the blocking disk 208.

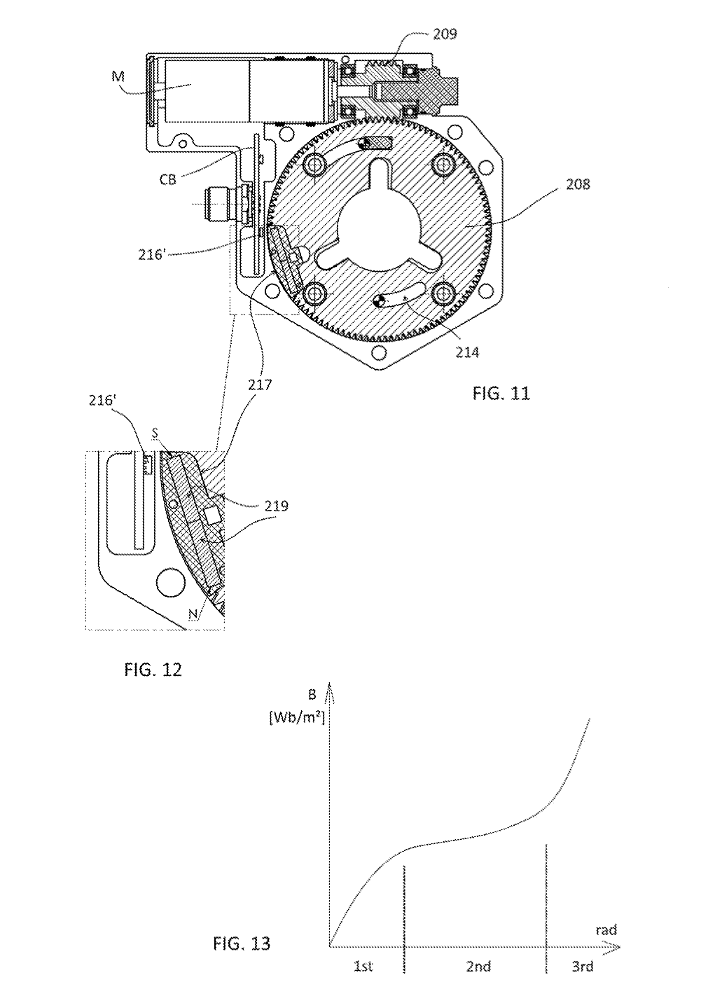

FIGS. 11 and 12 show this aspect in a better way. In practice, at the perimetrical edge of the blocking disk 208, a part of the respective teeth is removed to make a nick in which the magnet assembly 217 can be housed. The casing 218 remains substantially flush with the blocking disk 208 in order to not modify the bulk thereof.

The two magnets 219 are aligned so that to form a single magnetic field. Obviously, a single magnet can be alternatively used with a length equal to two magnets 219. Magnetic North pole and South pole are shown with letters N and S, respectively.

The sensor 216′, which can be defined rotation sensor, detects the strength of the magnetic field B generated by the magnet assembly 217. The detected strength B depends on the reciprocal distance between the sensor 216′ itself and the magnet assembly 217, and such a distance varies with the rotation of the blocking disk 208.

FIG. 13 is a qualitative chart of the strength of the magnetic field B the sensor 216′ detects, for example measurable in Tesla or Wb/m2, with respect to the angular position, measured in sexagesimal or radiant degrees, the blocking disk 208 assumes with respect to zero.

With the described arrangement the trend of the strength of the magnetic field B initially has an increase (area 1st) followed by an increase having a lower slope (area 2nd), in its turn followed by another slope increase similar to the first increase.

This allows the control unit connected to the printed circuit CB to distinguish at least three angular positions of the blocking disk 208 corresponding to:
assembly 300 released;
assembly 300 blocked;
the blocking disk 208 in the intermediate position.

If the blocking disk 208 remains in the intermediate position despite the device 100 has been ordered to release or block the assembly 300, this does mean that the disk 208 got jammed or the motor M does not work properly. The control unit generates an alarm signal with an assistance request, or it activates a self-diagnosis procedure.

In conclusion, the magnetic field B the sensor 216 can detect is a known function of the angular position of the blocking disk 208.

The invention can be implemented also by providing a discretized stepped B/rad diagram. It is sufficient to arrange more magnets 219 in series and spaced out from one another.

Preferably, in both the variations above described, the main body 201 is hermetic or almost hermetic, so that to withstand washing agents. For example, a gasket can be inserted between the two covers 201′ and 201″ screwed one to another. The device 100 can therefore undergo frequent washes with disinfectant and aggressive fluids, such those commonly used in medical field.

This feature takes a great importance if considered that the device 100 can be used to handle laboratory and diagnostic instruments automatically, but anyway in environments that must undergo frequent sanitizations in order to prevent patient infections.

Another important feature of the afore described devices 100 is the lightness. As can be deduced from the description above and by observing the enclosed figures, bulks of the device 100 are reduced to minimum. For example, the depth is a little greater than the outside diameter of motor M; length and width are a little greater than the diameter of the blocking disk 208. This is possible since the structure of the device 100 is strongly simple if compared to solutions according to known art.

For example, in device 100 according to the present invention, the blocking disk 208 is not necessarily supported by special bearings. As a matter of fact, as shown in figures, the blocking disk 208 can be simply supported along the respective circumference by the seat defined in the housing 201 by joined parts 201′ and 201″. Sacrificing the bearings also allows minimizing weight and simplifying the structure.

It follows that the weight is held down in values extremely lower than solutions of the known art, and this is an advantage for the dynamic behavior of the robot that will use the device 100 for object handling.

1. A tool quick changing device (100), comprising:
a main body (201) constrainable to the handling system;
a blocking disk (208) housed in the main body (201) and rotatable with respect to the main body (201), in opposite directions, on a rotation axis (X-X) between a blocking position and a releasing position;
a drive mechanism (M, 209), which drives the blocking disk (208) into rotation; and
a male portion (301) configured to be fastened to a tool to be handled,
wherein the main body (201) is provided with a seat (207) for housing the male portion (301) along said rotation axis (X-X), and
wherein the blocking disk (208), in the releasing position, does not intercept said seat (207) and, in the blocking position, the blocking disk (208) intercepts at least partially said seat (207) in order to hold the male portion (301) therein.

2. The device (100) according to claim 1, wherein the blocking disk (208) comprises a toothing (212) next to at least part of a perimeter thereof and the drive mechanism (209) engage the toothing (212).

3. The device (100) according to claim 1, wherein the drive mechanism (M, 209) comprises:
a reversible electric motor (M), having a shaft (M′), and a worm (209), both housed in the main body (201), wherein the worm (209) is constrained to the shaft (M′) and meshes the toothing (212) of the blocking disk (208), or;
a reversible electric motor (M), having a shaft (M′), outside the main body (201), a worm (209) housed in the main body (201) and a transmission element operatively connecting the shaft (M′) of the electric motor to the worm (209), wherein the worm (209) meshes the toothing (212) of the blocking disk (208), or;
a cylinder and piston assembly, which is pneumatically driven and wherein the piston is constrained to the blocking disk (208).

4. The device (100) according to claim 3, wherein the worm (209) is positioned substantially tangential to the blocking disk (208).

5. The device (100) according to claim 1, wherein the male portion (301) comprises two or more side projections (303), so that when the male portion (301) is inserted into a respective housing seat (207), the side projections (301) extend radially with respect to said rotation axis (X-X), and wherein the housing seat (207) in the main body (201) has a shape substantially complementary to the male portion (301).

6. The device (100) according to claim 5, wherein the male portion (301) is substantially cylindrical and is coaxially insertable into the housing seat (207) and wherein the projections (303) are pins radially arranged with angles at a center thereof of about 120°.

7. The device (100) according to claim 6, wherein the pins (303) rotate about themselves in respective seats obtained in the male portion (301), so that friction generated among the pins (30) and the blocking disk (208) while rotating is a rolling type friction.

8. The device (100) according to claim 5, wherein the blocking disk (208) is provided with a lobate through-hole coaxial with the rotation axis and in which the male portion is insertable, wherein the projections (303) of the male portion (301) are inserted into the housing seat (207) through the lobes (208′).

9. The device (100) according to claim 8, wherein a side of the blocking disk (208) facing a part opposed to the male portion (301), when the male portion is inserted into the housing seat (207), has at least one circumferential taper (215), or an inclined plane, at each lobe (208′), so that:
a rotation of the blocking disk (208) in the blocking position makes the tapers or inclined planes (215) intercept the respective projections (303) of the male portion (301) and generate an axial thrust onto the same tapers that blocks the male portion (301) on the main body, and
a rotation of the blocking disk (208) in the releasing position causes the tapers or inclined planes (215) not intercept the respective projections (303) of the male portion (301), thereby preventing the male portion (301) from withdrawing from the housing seat (207).

10. The device (100) according to claim 1, wherein the male portion (301) and the blocking disk (208) together generally define a bayonet coupling.

11. The device (100) according to claim 1, wherein the blocking disk (208) is positioned in the main body (201) at a median plane of the housing seat (207) of the male portion (301).

12. The device (100) according to claim 1, wherein the blocking disk (208) is housed in the main body (201) without the aid of bearings, thereby being supported only at its perimetrical edge by the main body (201) itself.

13. The device (100) according to claim 1, further comprising a magnetic proximity sensor arranged to generate a signal when the male portion (301) is correctly inserted into the housing seat (207).

14. The device (100) according to claim 1, comprising an encoder (216) housed in the main body (201) and arranged in order to each time detect an actual rotation amplitude of the blocking disk (208).

15. The device (100) according to claim 14, wherein the encoder (216) is configured to:
detect the number of teeth of the blocking disk (208) that pass in front of the encoder (216) itself when the blocking disk (208) is rotating, or
the encoder (216) comprises at least one permanent magnet (219) assembled on board of the blocking disk (208), next to the respective perimetrical edge, and a sensor (216′) of the strength (B) of the magnetic field generated by the at least one magnet (219), wherein the strength (B) of the magnetic field the sensor (216′) can detect is a function of the distance between the sensor (216′) and the at least one magnet (219) and, therefore, it is a function of the angular position of the blocking disk (208).

16. The device (100) according to claim 14, comprising an electronic circuit (CB) connected to said encoder (216) and to an electric motor (M), the electronic circuit (CB) being programmed to detect a possible current peak in the electric motor (M) and to receive the signal generated by said encoder (216), the signal being indicative of the rotation amplitude of the blocking disk (208) and to disrupt the electric power supply to the electric motor (M).

17. The device (100) according to claim 1, wherein the main body (201) comprises at least one gasket, which provide the main body (201) with a hermetic or nearly-hermetic closure, in order to allow the device to be washed frequently by detergents, or aggressive type detergents, without causing damage to inner components of the device.

18. Use of the device (100) according to claim 1 in a tool-handling apparatus in an industrial automation field or in ophthalmological diagnostic instruments of apparatuses that can be installed in public places.
